(19) United States
(12) Patent Application Publication
(10) Pub. No.: US 2022/0245519 A1
(43) Pub. Date: Aug. 4, 2022

(54) IDENTIFICATION APPARATUS, IDENTIFICATION METHOD AND RECORDING MEDIUM

(71) Applicant: NEC Corporation, Minato-ku, Tokyo (JP)

(72) Inventors: Taiki Miyagawa, Tokyo (JP); Akinori Ebihara, Tokyo (JP)

(73) Assignee: NEC Corporation, Minato-ku, Tokyo (JP)

(21) Appl. No.: 17/617,659

(22) PCT Filed: Apr. 30, 2020
(86) PCT No.: PCT/JP2020/018236

§ 371 Date: Dec. 9, 2021

(51) Int. Cl. G06N 20/00

(52) U.S. Cl. CPC G06N 20/00

(57) ABSTRACT

A learning apparatus includes: an identification unit that identifies a class of input data by using a learnable learning model; and an update unit that updates the learning model, by using an objective function based on relevance between a first index value for evaluating accuracy of a result of identification of the class of the input data and a second index value for evaluating time required to identify the class of the input data.

### TECHNICAL FIELD

The present disclosure relates to an identification apparatus, an identification method and a recording medium that identify a class of input data.

### BACKGROUND ART

An identification apparatus that identifies the class of the input data by using a learnable learning model (e.g., a learning model based on a neural network) is used in various fields. For example, when the input data are transaction data indicating the content of a transaction at a financial institution, an identification apparatus is used to identify whether a transaction corresponding to the transaction data inputted to the learning model is a normal transaction or a suspicious transaction.

Such an identification apparatus is desired to identify the class of the input data, accurately and quickly. For this reason, the learning model used by the identification apparatus is learned to satisfy an improvement in precision (i.e., accuracy) of a result of identification of the class of the input data and a reduction in time required to identify the class of the input data. For example, a Non-Patent Literature 1 describes a method of learning a learning model by using an objective function based on the sum of a loss function relating to the precision of the result of identification of the class of the input data and a loss function relating to the time required to identify the class of the input data.

In addition, Citation List of the present disclosure includes Patent Literatures 1 to 5 and a Non-Patent Literature 2.

### CITATION LIST

### Patent Literature

Patent Literature 1: JP2020-500377A
Patent Literature 2: JP2017-208044A
Patent Literature 3: JP2017-040616A
Patent Literature 4: JP2016-156638A
Patent Literature 5: JP2014-073134A

### Non-Patent Literature

Non-Patent Literature 1: Thomas Hartvigsen et al., “Adaptive-Halting Policy Network for Early Classification”, Proceedings of the 25th ACM SIGKDD International Conference on Knowledge Discovery & Data Mining, 2019
Non-Patent Literature 2: Don Kurian Dennis et al., “Multiple Instance Learning for Efficient Sequential Data Classification on Resource-constrained Devices”, Advances in Neural Information Processing Systems, 2018

### SUMMARY

### Technical Problem

The precision of the result of identification of the input data and the reduction in the time required to identify the class of the input data are generally in a trade-off relationship. In other words, when an attempt is made to prioritize the improvement in the precision of the result of identification of the class of the input data, there is a possibility that the reduction in the time required to identify the class of the input data is sacrificed to some extent. Similarly, when an attempt is made to prioritize the reduction in the time required to identify the class of the input data, there is a possibility that the improvement in the precision of the result of identification of the class of the input data is sacrificed to some extent.

Considering the existence of such a trade-off relationship, there is a possibility that both of the improvement in the precision of the result of identification of the class of the input data and the reduction in the time required to identify the class of the input data is not achievable by the objective function described in the Non-Patent Literature 1. Specifically, the objective function described in the Non-Patent Literature 1 is an objective function based on the sum of the loss function relating to the precision of the result of identification of the class of the input data (hereinafter, referred to as a “precision loss function”) and the loss function relating to the time required to identify the class of the input data (hereinafter, referred to as a “time loss function”). That is, the objective function described in the Non-Patent Literature 1 is an objective function based on the mere sum of the precision loss function and the time loss function that are calculated independently from each other (in other words, in an unrelated manner). Therefore, there is a possibility that the objective function described in the Non-Patent Literature 1 is determined to be minimized not only in a case where the precision loss function and the time loss function are small in a well-balanced manner, but also in each of a case where the time loss function is large to some extent even though the precision loss function is sufficiently small and a case where the precision loss function is large to some extent even though the time loss function is sufficiently small. Consequently, there is a possibility that the time required to identify the class of the input data is not sufficiently reduced even though the precision of the result of identification of the class of the input data is sufficiently guaranteed. In other words, there is a possibility that there is enough room to reduce the time required to identify the class of the input data. Similarly, there is a possibility that the precision of the result of identification of the class of the input data is not sufficient even though the time required to identify the class of the input data is sufficiently reduced. In other words, there is a possibility that there is enough room to improve the precision of the result of identification of the class of the input data.

It is an example object of the present disclosure to provide an identification apparatus, an identification method and a recording medium that are configured to solve the technical issues described above. By way of example, it is an example object of the present disclosure to provide an identification apparatus, an identification method and a recording medium that is configured to achieve both of the improvement in the precision of the result of identification of the class of the input data and the reduction in the time required to identify the class of the input data.

### Solution to Problem

An identification apparatus according to an example aspect of the present disclosure includes: an identification unit that identifies a class of input data by using a learnable learning model; and an update unit that updates the learning model, by using an objective function based on relevance between a first index value for evaluating accuracy of a result of identification of the class of the input data and a second index value for evaluating time required to identify the class of the input data.

An identification method according to an example aspect of the present disclosure includes: an identification step that identifies a class of input data by using a learnable learning model; and an update step that updates the learning model, by using an objective function based on relevance between a first index value for evaluating accuracy of a result of identification of the class of the input data and a second index value for evaluating time required to identify the class of the input data.

A recording medium according to an example aspect of the present disclosure is a recording medium on which a computer program that allows a computer to execute an identification method is recorded, the identification method including: an identification step that identifies a class of input data by using a learnable learning model; and an update step that updates the learning model, by using an objective function based on relevance between a first index value for evaluating accuracy of a result of identification of the class of the input data and a second index value for evaluating time required to identify the class of the input data.

### BRIEF DESCRIPTION OF DRAWINGS

FIG. 1 is a block diagram illustrating a configuration of an identification apparatus according to an example embodiment.

FIG. 2 is a block diagram illustrating a configuration of a learning model for performing an identification operation.

FIG. 3 is a graph illustrating the transition of a likelihood outputted by the learning model.

FIG. 4 is a flowchart illustrating a flow of a learning operation performed by the identification apparatus according to the example embodiment.

FIG. 5 is a graph illustrating the transition of a likelihood outputted by the learning model.

FIG. 6 is a data structure diagram illustrating a data structure of an identification result information that indicates a result of the identification operation performed by an identification unit.

FIG. 7 is a table illustrating a precision index value and a time index value.

FIG. 8 is a graph illustrating an evaluation curve calculated based on the precision index value and the time index value illustrated in FIG. 7.

FIG. 9 is a graph illustrating an evaluation curve.

FIG. 10 is a graph illustrating an evaluation curve before the learning operation is started and an evaluation curve after the learning operation is completed.

FIG. 11 is a graph illustrating an evaluation curve.

### DESCRIPTION OF EXAMPLE EMBODIMENTS

Hereinafter, an identification apparatus, an identification method and a recording medium according to an example embodiment will be described with reference to the drawings.

### (1) Configuration of Identification Apparatus 1 According to Example Embodiment

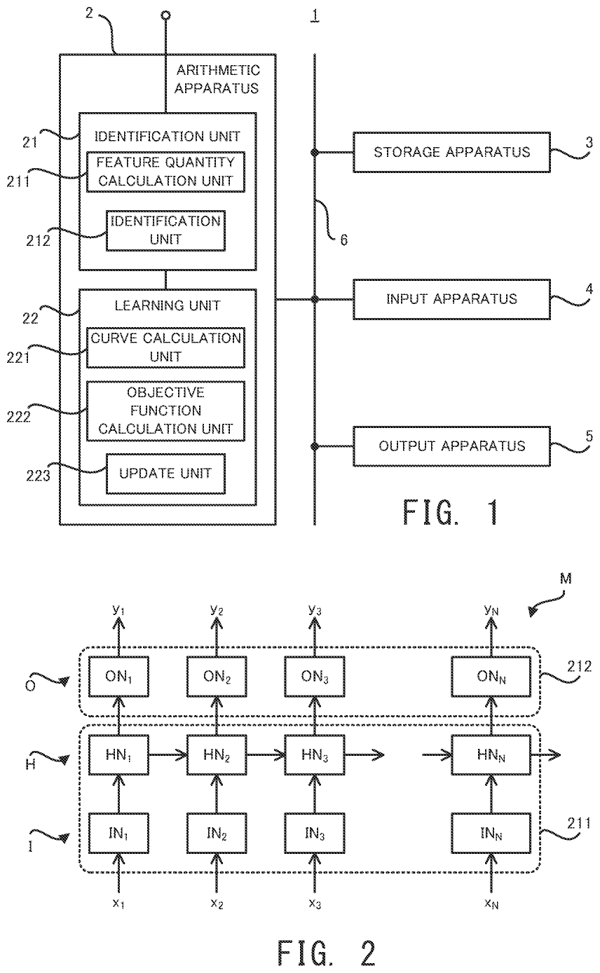

Firstly, with reference to FIG. 1, a configuration of the identification apparatus 1 according to the example embodiment will be described. FIG. 1 is a block diagram illustrating the configuration of the identification apparatus 1 according to the example embodiment.

As illustrated in FIG. 1, the identification apparatus 1 includes an arithmetic apparatus 2 and a storage apparatus 3. Furthermore, the identification apparatus 1 may include an input apparatus 4 and an output apparatus 5. However, the identification apparatus 1 may not include at least one of the input apparatus 4 and the output apparatus 5. The arithmetic apparatus 2, the storage apparatus 3, the input apparatus 4, and the output apparatus 5 may be connected through a data bus 6.

The arithmetic apparatus 2 includes, for example, at least one of a CPU (Central Processing Unit), a GPU (Graphic Processing Unit) and a FPGA (Field Programmable Gate Array). The arithmetic apparatus 2 reads a computer program. For example, the arithmetic apparatus 2 may read a computer program stored in the storage apparatus 3. For example, the arithmetic apparatus 2 may read a computer program stored by a computer-readable and non-temporary recording medium, by using a not-illustrated recording medium reading apparatus. The arithmetic apparatus 2 may obtain (i.e., downloaded or read) a computer program from a not-illustrated apparatus disposed outside the identification apparatus 1 via a not-illustrated communication apparatus. The arithmetic apparatus 2 executes the read computer program. Consequently, a logical functional block(s) for performing the operation to be performed by the identification apparatus 1 is implemented in the arithmetic apparatus 2. That is, the arithmetic apparatus 2 is configured to function as a controller for implementing the logical functional block(s) for performing the operation to be performed by the identification apparatus 1.

In the example embodiment, the arithmetic apparatus 2 performs an identification operation (in other words, a classification operation) for identifying a class of input data to be inputted to the identification apparatus 1. For example, the arithmetic apparatus 2 identifies whether the input data belongs to a first class or a second class that differs from the first class.

The input data is typically a series data containing a plurality of unit data that can be arranged systematically. For example, the input data may be a time series data containing a plurality of unit data that can be arrayed in time series. However, the input data may not necessarily be the series data. An example of such series data includes transaction data that indicates in time series the content of a transaction carried out by a user at a financial institution. In this instance, the arithmetic apparatus 2 may identify whether the transaction data belongs to a class relating to a normal transaction or to a class relating to a suspicious (in other words, unusual, illegal, or suspected to be involved in a fraud) transaction. That is, the arithmetic apparatus 2 may identify whether the transaction whose content is indicated by the transaction data is a normal transaction or a suspicious transaction.

An example of the transaction data includes data that indicates in time series the content of a series of transactions for transferring a desired amount of money to a transfer destination via an online site. For example, the transaction data may include: (i) unit data about the content of a process in which the user inputs a login ID that is used by the user for logging in the online site of a financial institution at a first time point; (ii) unit data about the content of a process in which the user inputs a password for logging in the online site at a second time point following the first time point; (iii) unit data about the content of a process in which the user inputs the transfer destination at a third time point following the second time point; (iv) unit data about the content of a process in which the user inputs a transfer amount at a fourth time point following the second time point; (v) unit data about the content of a process in which the user inputs a transaction password for completing the transfer at a fifth time point following the third and fourth time points. In this case, the arithmetic apparatus 2 identifies the class of the transaction data based on the transaction data containing the plurality of unit data. For example, the arithmetic apparatus 2 may identify whether the transfer transaction whose content is indicated by the transaction data is a normal transfer transaction or a suspicious (e.g., suspected to be involved in a transfer fraud) transfer transaction.

The arithmetic apparatus 2 identifies the class of the input data by using a learnable learning model M. The learning model M is, for example, a learning model that outputs a likelihood indicating a certainty that the input data belongs to a predetermined class (in other words, a probability that the input data belongs to the predetermined class) when the input data are inputted.

FIG. 1 illustrates an example of logical functional blocks implemented in the arithmetic apparatus 2 to perform the identification operation. As illustrated in FIG. 1, an identification unit 21, which is a specific example of the “identification unit”, is implemented in the arithmetic apparatus 2 as the logical functional block for performing the identification operation. The identification unit 21 identifies the class of the input data by using the learning model M. The identification unit 21 includes, as the logical functional blocks, a feature calculation unit 211 that is a part of the learning model M, and an identification unit 212 that is another part of the learning model M. The feature calculation unit 211 calculates a feature of the input data. The identification unit 212 identifies the class of the input data based on the feature calculated by the feature calculation unit 211.

As described above, when the input data is series data, the identification unit 21 may identify the class of the input data by using the learning model M based on a recurrent neural network (RNN). That is, the identification unit 21 may realize the feature calculation unit 211 and the identification unit 212 by using the learning model M based on the recurrent neural network.

FIG. 2 illustrates an example of a configuration of the learning model M based on the recurrent neural network for realizing the feature calculation unit 211 and the identification unit 212. As illustrated in FIG. 2, the learning model M may include an input layer I, a hidden layer H, and an output layer O. The input layer I and the hidden layer H correspond to the feature calculation unit 211. The output layer O corresponds to the identification unit 212. The input layer I may include N input nodes IN (specifically, input nodes IN₁ to IN_{N}) (where N is an integer of 2 or more). The hidden layer N may include N hidden nodes HN (specifically, hidden nodes HN₁ to HN_{N}). The output layer O may include N output nodes ON (specifically, output nodes ON₁ to ON_{N}).

N unit data x (specifically, unit data x₁ to x_{N}) contained in the series data are respectively inputted to the N input nodes N₁ to IN_{N}. The N unit data x₁ to x_{N} inputted to the N input nodes IN₁ to IN_{N} are respectively inputted to the N hidden nodes HN₁ to HN_{N}. Incidentally, each hidden node HN may be, for example, a node conforming to a LSTM (Long Short Term Memory), or may be a node conforming to the other network structure. The N hidden nodes HN₁ to HN_{N} respectively output the features of the N unit data x₁ to x_{N} to the N output nodes ON₁ to ON_{N}. Furthermore, each hidden node HNₖ (where k is a variable representing an integer that is greater than or equal to 1 and is less than or equal to N) inputs the feature of each unit data xₖ to the next hidden node HNₖ₊₁ as illustrated by a horizontal arrow in FIG. 2. Therefore, each hidden node HNₖ outputs, to the output node ONₖ, the feature of the unit data xₖ in which the features of the unit data x₁ to xₖ₋₁ are reflected, based on the unit data xₖ and the feature of the unit data xₖ₋₁ outputted by the hidden node HNₖ₋₁. Therefore, it can be said that the feature of the unit data xₖ outputted by each hidden node HNₖ substantially represents the feature of the unit data x₁ to xₖ.

Each output node ONₖ outputs a likelihood yₖ indicating a certainty that the series data belongs to a predetermined class based on the feature of the unit data xₖ outputted by the hidden node HNₖ. The likelihood yₖ corresponds to a likelihood indicating the certainty that the series data belongs to a predetermined class, which is estimated based on k unit data x₁ to xₖ of the N unit data x₁ to x_{N} contained in the series data. As described above, the identification unit 212 including the N output nodes ON₁ to ON_{N} successively outputs N likelihoods y₁ to y_{N}, which respectively correspond to the N unit data x₁ to x_{N}.

The identification unit 212 identifies the class of the series data based on the N likelihoods y₁ to y_{N}. Specifically, the identification unit 212 determines whether or not the likelihood y₁, which is firstly outputted, is greater than or equal to a predetermined first threshold T1 (where T1 is a positive number), or whether or not the likelihood y₁ is less than or equal to a predetermined second threshold T2 (where T1 is a negative number). Note that the absolute value of the first threshold T1 and the absolute value of the second threshold T2 are typically the same, but may be different. When it is determined that the likelihood y1 is greater than or equal to the first threshold T1, the identification unit 212 determines that the series data belongs to the first class. For example, when the series data is the above-described transaction data, the identification unit 212 determines that the series data belongs to the class relating to the normal transaction. When it is determined that the likelihood y₁ is less than or equal to the second threshold T2, the identification unit 212 determines that the series data belongs to the second class. For example, when the series data are the above-described transaction data, the identification unit 212 determines that the series data belongs to the class relating to the suspicious transaction. On the other hand, when it is determined that the likelihood y1 is not greater than or equal to the first threshold T1 and is not less than or equal to the second threshold T2, the identification unit 212 determines whether the likelihood y2, which is outputted after the likelihood y₁, is greater than or equal to the first threshold T1 and whether or not the likelihood y2 is less than or equal to the second threshold T2. Then, the same operation is repeated until it is determined that the likelihood yₖ is greater than or equal to the first threshold T1, or until it is determined that the likelihood yₖ is less than or equal to the second threshold T2.

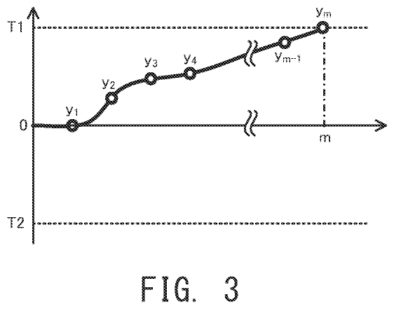

FIG. 3 is a graph illustrating the transition of the likelihoods y₁ to yₘ when it is determined that the likelihood yₘ, which is the m-th to output (where m is an integer that is greater than or equal to 1 and is less than or equal to N), is greater than or equal to the first value T1. In this case, when the unit data xₘ is inputted to the learning model M, it is determined for the first time that the likelihood yₘ calculated based on the unit data xₘ is greater than or equal to the first threshold T1. That is, when the unit data xₘ is inputted to the learning model M, the identification of the class of the series data is completed. In other words, the identification of the class of the series data is not completed until the unit data xₘ is inputted to the learning model M. Therefore, it can be said that it takes a shorter time to identify the class of the series data as the variable m is smaller (i.e., the number of the unit data x inputted to the learning model M is smaller). In other words, it can be said that it takes a longer time to identify the class of the series data as the variable m is larger (i.e., the number of the unit data x inputted to the learning model M is larger).

Referring again to FIG. 1, the identification apparatus 1 further performs a learning operation of allowing the learning model M to learn (in other words, an updating operation of updating the learning model M) based on a result of identification of the class of the input data (the series data) by the identification unit 21. FIG. 1 illustrates an example of the logical functional blocks implemented in the arithmetic apparatus 2 to perform the learning operation. As illustrated in FIG. 1, a learning unit 22, which is a specific example of the “updating unit”, is implemented in the arithmetic apparatus 2 as the logical functional block for performing the learning operation. The learning unit 22 includes a curve calculation unit 221, an objective function calculation unit 222, and an updating unit 223. A description of the respective operations of the curve calculation unit 221, the objective function calculation unit 222, and the updating unit 223 will be omitted here because it will be described later when the learning operation is explained.

The storage apparatus 3 is configured to store desired data. For example, the storage apparatus 3 may temporarily store a computer program to be executed by the arithmetic apparatus 2. The storage apparatus 3 may temporarily store the data that are temporarily used by the arithmetic apparatus 2 when the arithmetic apparatus 2 executes the computer program. The storage apparatus 3 may store the data that are stored for a long term by the identification apparatus 1. The storage apparatus 3 may include at least one of a RAM (Random Access Memory), a ROM (Read Only Memory), a hard disk apparatus, a magnetic-optical disk apparatus, an SSD (Solid State Drive), and a disk array apparatus. That is, the storage apparatus 3 may include a non-transitory recording medium.

The input apparatus 4 is an apparatus that receives an input of information on identification apparatus 1 from the outside of identification apparatus 1.

The output apparatus 5 is an apparatus that outputs information to the outside of the identification apparatus 1. For example, the output apparatus 5 may output information about at least one of the identification operation and the learning operation performed by the identification apparatus 1. For example, the output apparatus 5 may output information about the learning model M that has learned by the learning operation.

### (2) Flow of Learning Operation Performed by Identification Apparatus 1

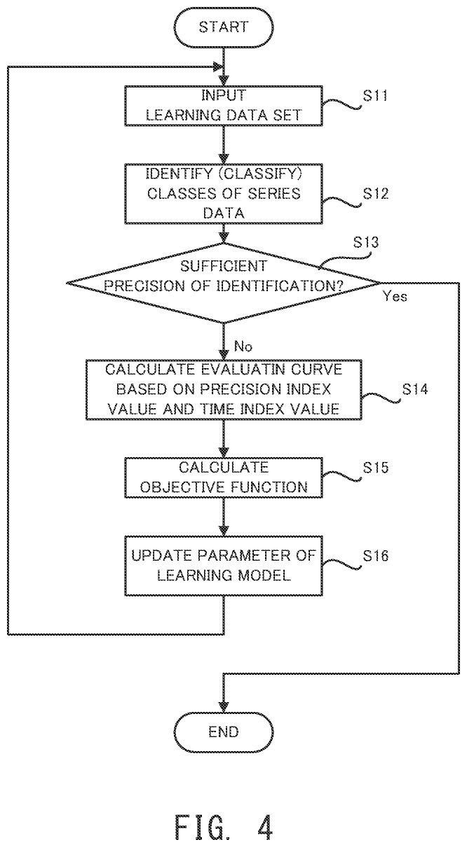

Next, with reference to FIG. 4, a flow of the learning operation performed by the identification apparatus 1 according to the example embodiment will be described. FIG. 4 is a flowchart illustrating the flow of the learning operation performed by the identification apparatus 1 according to the example embodiment.

As illustrated in FIG. 4, a learning data set containing a plurality of learning data in each of which the series data is associated with ground truth labels (i.e., ground truth class) of the class of the series data is inputted to the identification unit 21 (step S11). Then, the identification unit 21 performs the identification operation on the learning data set inputted in the step S11 (step S12). That is, the identification unit 21 identifies the the classes of the plurality of the series data contained in the learning data set inputted in the step S11 (step S12). Specifically, the feature calculation unit 211 of the identification unit 21 calculates the features of the unit data x₁ to x_{N} contained in each of the series data. The identification unit 212 of the identification unit 21 calculates the likelihoods y₁ to y_{N} based on the features calculated by the feature calculation unit 211, and compares each of the calculated likelihoods y₁ to y_{N} with each of the first threshold T1 and the second threshold T2, thereby to identify the class of the series data.

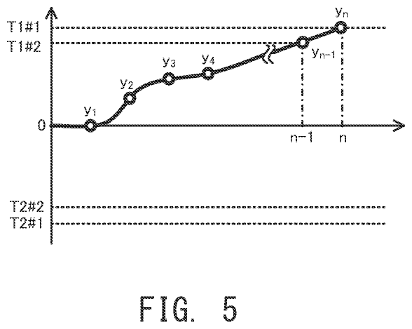

In the example embodiment, the identification unit 212 repeats the operation of comparing each of the likelihoods y₁ to y_{N} with each of the first threshold T1 and the second threshold T2 to identify the class of the series data, while changing the first threshold T1 and the second threshold T2. For example, as illustrated in FIG. 5, which illustrates the transition of the likelihoods y₁ to y_{N}, the identification unit 212 sets a first threshold T1 #1 and a second threshold T2 #1 respectively for the first threshold T1 and the second threshold T2, and compares each of the likelihoods y₁ to y_{N} with each of the first threshold T1 #1 and the second threshold T2 #1, thereby to identify the class of the series data. In the example illustrated in FIG. 5, when unit data xₙ is inputted to the learning model M, it is determined for the first time that a likelihood yₙ calculated based on the unit data xₙ is greater than or equal to the first threshold T1 #1. Therefore, the identification unit 212 spends time that elapses until the unit data xₙ is inputted to the learning model M, in order to identify that the series data belongs to the first class. Then, for example, the identification unit 212 sets a first threshold T1 #2, which is different from the first threshold T1 #1, and a second threshold T2 #2, which is different from the second threshold T2 #1, respectively for the first threshold T1 and the second threshold T2, and compares each of the likelihoods y₁ to y_{N} with each of the first threshold T1 #2 and the second threshold T2 #2, thereby to identify the class of the series data. In the example illustrated in FIG. 5, when unit data xₙ₋₁ is inputted to the learning model M, it is determined for the first time that a likelihood yₙ₋₁ calculated based on the unit data xₙ₋₁ is greater than or equal to the first threshold T1 #2. For this reason, the identification unit 212 spends time that elapses until the unit data xₙ₋₁ is inputted to the learning model M in order to identify that the series data belongs to the first class.

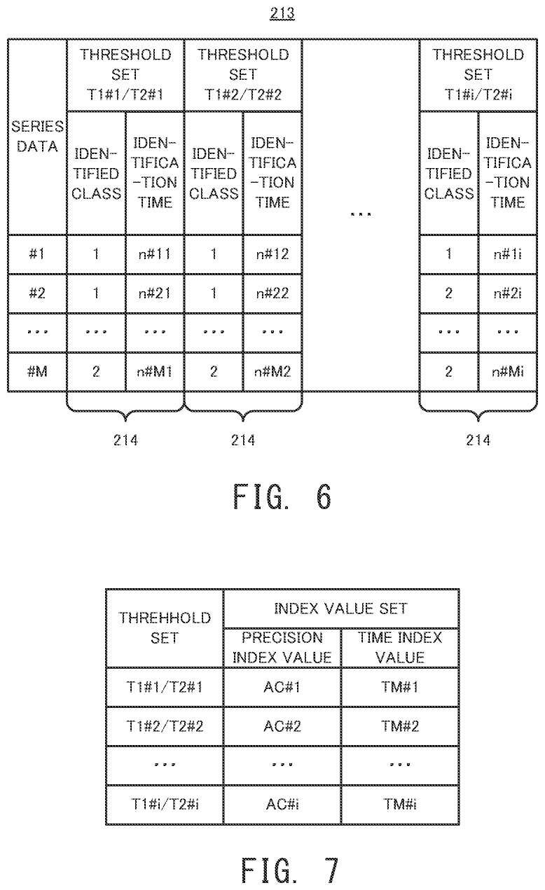

As a result, the identification unit 21 outputs an identification result information 213 indicating a result of the identification operation performed by the identification unit 21 in the step S12, to the learning unit 22. An example of the identification result information 213 is illustrated in FIG. 6. As illustrated in FIG. 6, the identification result information 213 includes data sets 214 in each of which the result (identified class) of identification of the class of each of the plurality of series data contained in the learning data set is associated with time (identification time) required to complete the identification of the class of each series data, wherein the number of the data sets 214 is equal to the number of threshold sets each of which is a combination of the first threshold T1 and the second threshold T2. FIG. 6 illustrates the identification result information 213 that is obtained when the number of the series data contained in the learning data set is M (where M is an integer of 2 or more) and the number of the threshold sets is i (where i is an integer of 2 or more).

Then, the learning unit 22 determines whether or not identification precision (note that the identification precision may be referred to as “performance”) of the class of the series data identified by the identification unit 21 is sufficient, based on the identification result information 213 (step S13). For example, the learning unit 22 may determine that the identification precision is sufficient when a precision index value for evaluating the identification precision (i.e., accuracy of the result of identification of the series data) exceeds a predetermined allowable threshold. In this case, the learning unit 22 may calculate the precision index value by comparing the identified class included in the identification result information 213 with the ground truth class included in the learning data set. For example, any index that is used in binary classification may be used as the precision index value. An example of the index that is used in the binary classification includes at least one of the followings: for example, accuracy, balanced accuracy, precision, recall, F value, informedness, markedness, G mean, and Matthews correlation coefficient. In this case, the precision index value increases as the identification precision is increased. As illustrated in FIG. 6, in the example embodiment, the identification result information 213 includes sets of the respective identified class (and identification times) of the plurality of series data contained in the learning data set, wherein the number of the sets of the identified class and identification times is equal to the number of combinations of the first threshold T1 and the second threshold T2 (i.e., the number of the threshold sets). In this case, the learning unit 22 may calculate the precision index value by using a set of the identified class corresponding to one threshold set. Alternatively, the learning unit 22 may calculate a mean value of a plurality of precision index values corresponding to a plurality of threshold sets.

As a result of the determination in the step S13, when it is determined that the identification precision is sufficient (the step S13: Yes), it is estimated that the learning model M has been sufficiently learned to the extent that the class of the series data can be identified with sufficiently high precision by using the learning model M. Therefore, in this case, the identification apparatus 1 ends the learning operation illustrated in FIG. 4.

On the other hand, as a result of the determination in the step S13, when it is determined that the identification precision is not sufficient (the step S13: No), the identification apparatus 1 continues the learning operation illustrated in FIG. 4. In this case, firstly, the curve calculation unit 221 of the learning unit 22 calculates an evaluation curve PEC based on the identification result information 213 (step S14). The evaluation curve PEC indicates relevance between the precision index value described above and a time index value described below. Specifically, the evaluation curve PEC is a curve that indicates the relevance between the precision index value and the time index value, on a coordinate plane defined by two coordinate axes respectively corresponding to the precision index value and the time index value. The time index value is an index value for evaluating time required by the identification unit 21 to identify the class of the series data (i.e., speed to complete the identification of the class of the series data, which may be referred to as Earliness). As described above, the evaluation result information 213 includes the identification time. The time index value may be an index value determined based on this identification time. For example, the time index value may be at least one of a mean value of the identification time and a median value of an identification time. In this case, the time index value increases as the identification time is longer.

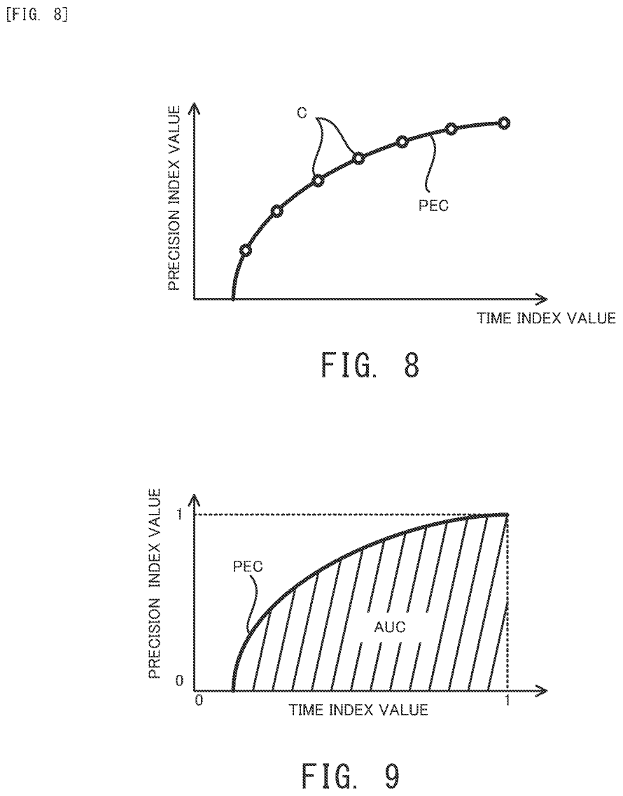

Hereinafter, with reference to FIG. 7 and FIG. 8, the evaluation curve PEC will be described. FIG. 7 is a table illustrating the precision index value and the time index value. FIG. 8 is a graph illustrating the evaluation curve PEC calculated based on the precision index value and the time index value illustrated in FIG. 7.

In order to calculate the evaluation curve PEC, the curve calculation unit 221 firstly calculates the precision index value and the time index value based on the evaluation result information 213. Specifically, as described above, the identification result information 213 includes the sets of the identified class and identification times of the plurality of series data contained in the learning data set, wherein the number of the sets is equal to the number of combinations of the first threshold T1 and the second threshold T2 (i.e., the number of the threshold sets). In this case, the curve calculation unit 221 calculates the precision index value and the time index value, for each threshold set. For example, the curve calculation unit 221 calculates the precision index value (a precision index value AC #1 in FIG. 7) based on the identified class corresponding to a first threshold set including the first threshold T1 #1 and the second threshold T2 #1, and calculates the time index value (a time index value TM #1 in FIG. 7) based on the identification time corresponding to the first threshold set. Furthermore, the curve calculation unit 221 calculates the precision index value (a precision index value AC #2 in FIG. 7) based on the identified class corresponding to a second threshold set including the first threshold T1 #2 and the second threshold T2 #2, and calculates the time index value (a time index value TM #2 in FIG. 7) based on the identification time corresponding to the second threshold set. Thereafter, the curve calculation unit 221 repeats the operation of calculating the precision index value and the time index value until the calculation of the precision index value and the time index value for all the threshold set is completed. As a result, as illustrated in FIG. 7, the curve calculation unit 221 calculates index value sets, each of which includes the precision index value and the time index value, wherein the number of the index value sets is equal to the number of the threshold sets. At this time, each of the precision index value and the time index value calculated by the curve calculation unit 221 is preferably normalized such that that the minimum value is 0 and that the maximum value is 1.

Then, as illustrated in FIG. 8, the curve calculation unit 221 plots coordinate points C, each of which corresponds to the precision index value and the time index value included in respective one of the calculated index value sets, on the coordinate plane defined by the two coordinate axes respectively corresponding to the precision index value and the time index value. Then, the curve calculation unit 221 calculates a curve that connects the plotted coordinate points C, as the evaluation curve PEC. Such an evaluation curve PEC is typically a curve indicating that a precision evaluation value increases as the time index value is increased. For example, when the vertical and horizontal axes respectively correspond to the precision index value and time index value, the evaluation curve PEC is a curve with an upward slope on the coordinate plane.

In FIG. 4 again, after that, the objective function calculation unit 222 calculates an objective function L to be used in the learning of a learning model G based on the evaluation curve PEC calculated in the step S14 (step S15). Specifically, as illustrated in FIG. 9, which is a graph illustrating the evaluation curve PEC, the objective function calculation unit 222 calculates the objective function L based on a square measure S of an area AUC (Area Under Curve) that is under the evaluation curve PEC. That is, the objective function calculation unit 222 calculates the objective function L based on the square measure S of the area AUC surrounded by the evaluation curve PEC and the two coordinate axes. More specifically, as described above, since each of the precision index value and the time index value is normalized such that the minimum value is 0 and that the maximum value is 0, the objective function calculation unit 222 calculates the objective function L based on the square measure S of the area AUC surrounded by the evaluation curve PEC and the two coordinate axes in a range in which the time index value ranges from the minimum value of 0 to the maximum value of 1 and the precision index value ranges from the minimum value of 0 to the maximum value of 1 (in the example illustrated in FIG. 11, the area AUC surrounded by the evaluation curve PEC, the horizontal axis corresponding to the time index value, and a straight line specified by an equation that is the time index value=1). As an example, as described above, when each of the precision index value and the time index value is normalized such that the minimum value is 0 and that the maximum value is 1, the square measure of the area AUC is also normalized such that the minimum value is 0 and that the maximum value is 1. When the square measure S of the area AUC is normalized in this manner, the objective function calculation unit 222 may use an equation L=(1−S)² to calculate the objective function L.

Incidentally, as described above, the evaluation curve PEC indicates the relevance between the precision index value and the time index value. Therefore, the objective function L based on the evaluation curve PEC may be regarded as an objective function based on the relevance between the precision index value and the time index value.

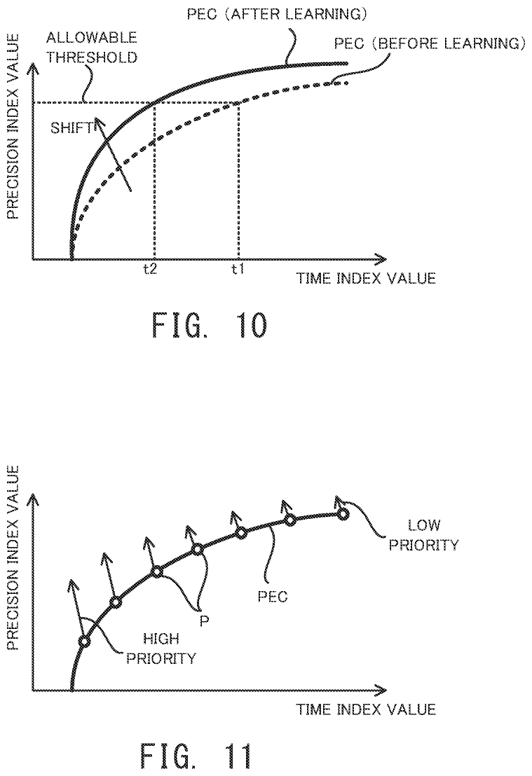

Then, the updating unit 223 updates a parameter of the learning model G based on the objective function L calculated in the step S15 (step S16). In the example embodiment, the updating unit 223 updates the parameter of the learning model G to maximize the square measure S of the area AUC under the evaluation curve PEC. When the objective function L is calculated by using the above equation L=(1−S)², the updating unit 223 updates the parameter of the learning model G to minimize the objective function L. At this time, the updating unit 223 may update the parameter of the learning model G by using a known learning algorithm, such as an back propagation method. Here, minimizing the objective function L may be regarded as aiming at steepening a slope at the rise of the evaluation curve PEC. As the evaluation curve PEC has a steeper rise, it takes a shorter time for the precision index value to reach a certain threshold (e.g., an allowable threshold illustrated in FIG. 10 described later). Therefore, the identification apparatus 1 is capable of outputting the result of identification of the inputted series data at a high speed.

Then, the identification apparatus 1 repeats the operation after the step S11 until it is determined that the identification precision is sufficient in the step S13. That is, a new learning data set is inputted to the identification unit 21 (the step S11). The identification unit 21 performs the identification operation on the learning data set newly inputted in the step S11, by using the learning model M whose parameter is updated in the step S17 (the step S12). The curve calculation unit 221 recalculates the evaluation curve PEC based on the identification result information 213 indicating the result of identification of the class using the updated learning model M (the step S14). The objective function calculation unit 222 recalculates the objective function L based on the recalculated evaluation curve PEC (the step S15). The updating unit 223 updates the parameter of the learning model G based on the recalculated objective function L (the step S16).

### (3) Technical Effect of Identification Apparatus 1

As described above, the identification apparatus 1 according to the example embodiment updates the parameter of the learning model G (i.e., performs the learning of the learning model M) by using the objective function L based on the evaluation curve PEC. Specifically, the identification apparatus 1 updates the parameter of the learning model G (i.e., performs the learning of the learning model M) to maximize the square measure S of the area AUC under the evaluation curve PEC. Here, as illustrated in FIG. 10, which is a graph illustrating the evaluation curve PEC before the learning operation is started and the evaluation curve PEC after the learning operation is completed, when the learning of the learning model M is performed to increase the square measure S of the area AUC, the evaluation curve PEC is shifted upward to the left on the coordinate plane. When the evaluation curve PEC is shifted upward to the left on the coordinate plane, the minimum value of the time index value for realizing that the precision evaluation value exceeds the allowable threshold (i.e., for realizing a condition in which the identification precision is sufficient) is reduced. For example, in the example illustrated in FIG. 10, before the learning operation is started, the minimum value of the time index value for realizing that the precision evaluation value exceeds the allowable threshold is a value t1. On the other hand, after the learning operation is completed, the minimum value of the time index value for realizing that the precision evaluation value exceeds the allowable threshold is a value t2, which is smaller than the value t1. Such a reduction in the minimum value of the time index value for realizing that the precision evaluation value that exceeds the allowable threshold means that it takes a shorter time to identify the class of the input data with the identification precision that exceeds the allowable threshold. Therefore, in the example embodiment, the identification apparatus 1 is capable of achieving both an improvement in the identification precision of the class of the input data (i.e., accuracy of the result of identification of the class) and a reduction in the identification time required to identify the class of the input data.

One of the reasons why such a technical effect is achievable that it is possible to achieve both of the identification precision and the reduction in the identification time is the use of the objective function L based on the relevance (i.e., relationship) between the precision index value and the time index value (specifically, the objective function L based on the evaluation curve PEC). Hereinafter, the reason why such a technical effect is achievable will be described with reference to a comparative example in which the sum a loss function that is based on the precision index value but that does not take into account the time index value (hereinafter referred to as a “precision loss function”) and a loss function that is based on the time index value but that does not take into account the precision index value (hereinafter referred to as a “time loss function”) is used as the objective function. Specifically, there is a possibility that the objective function in the comparative example is determined to be minimized not only in a case where both of the precision loss function and the time loss function are small in a well-balanced manner, but also in each of a case where the time loss function is unacceptably large even though the precision loss function is sufficiently small and a case where the precision loss function is unacceptably large even though the time loss function is sufficiently small. Consequently, there is a possibility that the identification time is not sufficiently reduced even though the identification precision is sufficiently guaranteed (i.e., there is enough room to reduce the identification time). Similarly, there is a possibility that the identification precision is not sufficient even though the identification time is sufficiently reduced (i.e., there is enough room to improve the identification precision). In the example embodiment, however, the objective function L based on the relevance between the precision index value and the time index value is used. Therefore, by using such an objective function L, the identification apparatus 1 is capable of performing the learning of the learning model M while substantially taking into account how the precision index value changes with a change in the time index value when the time index value changes due to the learning of the learning model M. Similarly, by using such an objective function L, the identification apparatus 1 is capable of performing the learning of the learning model M while substantially taking into account how the time index value changes with a change in the precision index value when the precision index value changes due to the learning of the learning model M. This is because the objective function L is an object function based on the relevance between the precision index value and the time index value (i.e., relevance indicating how one of the precision index value and the time index value changes when the other one changes). Therefore, in the example embodiment, as compared with the comparative example, when the learning operation is completed, the following is a relatively unlikely situation; namely, the identification time is not sufficiently reduced even though the identification precision is sufficiently guaranteed; and the identification precision is not sufficient even though the identification time is sufficiently reduced. Consequently, the identification apparatus 1 is capable of achieving both of the improvement in the identification precision of the class of the input data (i.e., the accuracy of the result of identification of the class) and the reduction in the identification time required to identify the class of the input data.

### (4) Modified Example

In the above description, the learning unit 22 performs the learning of the learning model M by using the objective function L based on the square measure S of the area AUC under the evaluation curve PEC. The learning unit 22, however, may use any objective function L that is determined based on the evaluation curve PEC, in addition to or in place of the objective function L based on the square measure S of the area AUC, thereby to perform the learning of the learning model M. For example, as illustrated in FIG. 11, which is a graph illustrating the evaluation curve PEC, the learning unit 22 may perform the learning of the learning model M by using the objective function L based on the position of at least one sample point P on the evaluation curve PEC. In this case, the learning unit 22 may perform the learning of the learning model M by using the objective function L based on the position of at least one sample point P, so as to maximally shift at least one sample point P on the evaluation curve PEC upward to the left on the coordinate plane, in other words, so as to maximize the slope of the evaluation curve PEC at a particular point P set in a rise part of the evaluation curve PEC (specifically, a curve part in an area with the smallest time index value in FIG. 11). Here, the learning unit 22 may prioritize the improvement in the precision index value of the sample point P with a relatively small time index value, over the improvement in the precision index value of the sample point P with a relatively large time index value, so as to efficiently shift the evaluation curve PEC upward to the left on the coordinate plane. That is, the objective function L based on the position of at least one sample point P may be calculated so that the weight of the sample point P increases as the time index value corresponding to the sample point P is smaller.

Alternatively, the learning unit 22 may perform the learning of the learning model M by using any objective function L that is based on the relevance between the precision index value and the time index value, in addition to or in place of the objective function L based on the evaluation curve PEC.

In the above description, in the step S13 in FIG. 4, the learning unit 22 determines whether or not the identification precision of the class of the series data identified by the identification unit 21 is sufficient based on the precision index value. The learning unit 22, however, may determine whether or not the identification precision of the class of the series data identified by the identification unit 21 is sufficient based on the area AUC under the evaluation curve PEC. For example, the learning unit 22 may determine that the identification precision of the class of the series data identified by the identification unit 21 is sufficient when the square measure S of the area AUC under the evaluation curve PEC is larger than an allowable area.

In the above description, the identification apparatus 1 identifies whether the transaction whose content is indicated by transaction data is the normal transaction or the suspicious transaction, based on the transaction data that indicates in time series the content of the transaction carried out by the user at the financial institution. The use of the identification apparatus 1, however, is not limited to the identification of the class of the transaction data. For example, the identification apparatus 1 may identify whether an imaging target is a living body (e.g., a human) or an artifact that is not a living body, based on time series data containing, as a plurality of unit data, a plurality of images obtained by continuously capturing an image of the imaging target that moves toward an imaging apparatus. In other words, the identification apparatus 1 may perform so-called liveness detection (in other words, impersonation detection).

The present disclosure is not limited to the above-described examples and is allowed to be changed, if desired, without departing from the essence or spirit of the invention which can be read from the claims and the entire specification. An identification apparatus, an identification method, a computer program and a recording medium with such changes are also intended to be within the technical scope of the present disclosure.

### DESCRIPTION OF REFERENCE CODES

1 Identification apparatus
2 Arithmetic apparatus
21 Identification unit
211 Feature calculation unit
212 Identification unit
22 Learning unit
221 Curve calculation unit
222 Objective function calculation unit
223 Update unit

What is claimed is:

1. A learning apparatus comprising
at least one memory configured to store instructions; and
at least one processor configured to execute the instructions to:
identify a class of input data by using a learnable learning model; and
update the learning model, by using an objective function based on relevance between a first index value for evaluating accuracy of a result of identification of the class of the input data and a second index value for evaluating time required to identify the class of the input data.

2. The identification apparatus according to claim 1, wherein
the objective function includes a function based on a curve that indicates the relevance on a coordinate plane including two coordinate axes respectively corresponding to the first and second index values.

3. The identification apparatus according to claim 2, wherein
the objective function includes a function based on a square measure of an area under the curve.

4. The identification apparatus according to claim 3, wherein
when each of the first and second index values is normalized so that a minimum value is 0 and a maximum value is 1, the area under the curve is an area that is surrounded by the curve, one coordinate axis corresponding to the time index value of the two coordinate axes, and a straight line represented by an equation that is the time index value=1.

5. The identification apparatus according to claim 3, wherein
the objective function is defined by using an equation L=(1−S)², wherein L is the objective function and S is the square measure that is normalized so that the maximum value is 1.

6. The identification apparatus according to claim 3, wherein
the at least one processor is configured to execute the instructions to update the learning model by using the objective function to maximize the square measure.

7. The identification apparatus according to claim 1, wherein
the learning model outputs a likelihood indicating a certainty that the input data belongs to a predetermined class, when the input data is inputted,
the at least one processor is configured to execute the instructions to:
identify the class of the input data based on a magnitude correlation between the likelihood and a predetermined threshold; and
(i) calculate the first and second index values based on the result of identification using a plurality of different predetermined thresholds, (ii) calculate the objective function based on the calculated first and second index values, and (iii) update the learning model by using the calculated objective function.

8. The identification apparatus according to claim 1, wherein
the input data include series data containing a plurality of sub data that can be arranged systematically, and
the learning model outputs a plurality of likelihoods, each indicating a certainty that the series data belongs to a predetermined class, correspondingly to each of the plurality of sub data, when the series data is inputted.

9. A learning method comprising:
identifying a class of input data by using a learnable learning model; and
updating the learning model, by using an objective function based on relevance between a first index value for evaluating accuracy of a result of identification of the class of the input data and a second index value for evaluating time required to identify the class of the input data.

10. A non-transitory recording medium on which a computer program that allows a computer to execute an identification method is recorded,
the identification method comprising:
identifying a class of input data by using a learnable learning model; and
updating the learning model, by using an objective function based on relevance between a first index value for evaluating accuracy of a result of identification of the class of the input data and a second index value for evaluating time required to identify the class of the input data.

11. The identification apparatus according to claim 4, wherein
the objective function is defined by using an equation L=(1−S)², wherein L is the objective function and S is the square measure that is normalized so that the maximum value is 1.

12. The identification apparatus according to claim 4, wherein
the at least one processor is configured to execute the instructions to update the learning model by using the objective function to maximize the square measure.

13. The identification apparatus according to claim 5, wherein
the at least one processor is configured to execute the instructions to update the learning model by using the objective function to maximize the square measure.

14. The identification apparatus according to claim 2, wherein
the learning model outputs a likelihood indicating a certainty that the input data belongs to a predetermined class, when the input data is inputted,
the at least one processor is configured to execute the instructions to:
identify the class of the input data based on a magnitude correlation between the likelihood and a predetermined threshold; and
(i) calculate the first and second index values based on the result of identification using a plurality of different predetermined thresholds, (ii) calculate the objective function based on the calculated first and second index values, and (iii) update the learning model by using the calculated objective function.

15. The identification apparatus according to claim 3, wherein
the learning model outputs a likelihood indicating a certainty that the input data belongs to a predetermined class, when the input data is inputted,
the at least one processor is configured to execute the instructions to:
identify the class of the input data based on a magnitude correlation between the likelihood and a predetermined threshold; and
(i) calculate the first and second index values based on the result of identification using a plurality of different predetermined thresholds, (ii) calculate the objective function based on the calculated first and second index values, and (iii) update the learning model by using the calculated objective function.

16. The identification apparatus according to claim 4, wherein
the learning model outputs a likelihood indicating a certainty that the input data belongs to a predetermined class, when the input data is inputted,
the at least one processor is configured to execute the instructions to:
identify the class of the input data based on a magnitude correlation between the likelihood and a predetermined threshold; and
(i) calculate the first and second index values based on the result of identification using a plurality of different predetermined thresholds, (ii) calculate the objective function based on the calculated first and second index values, and (iii) update the learning model by using the calculated objective function.

17. The identification apparatus according to claim 5, wherein
the learning model outputs a likelihood indicating a certainty that the input data belongs to a predetermined class, when the input data is inputted,
the at least one processor is configured to execute the instructions to:
identify the class of the input data based on a magnitude correlation between the likelihood and a predetermined threshold; and
(i) calculate the first and second index values based on the result of identification using a plurality of different predetermined thresholds, (ii) calculate the objective function based on the calculated first and second index values, and (iii) update the learning model by using the calculated objective function.

18. The identification apparatus according to claim 6, wherein
the learning model outputs a likelihood indicating a certainty that the input data belongs to a predetermined class, when the input data is inputted,
the at least one processor is configured to execute the instructions to:
identify the class of the input data based on a magnitude correlation between the likelihood and a predetermined threshold; and
(i) calculate the first and second index values based on the result of identification using a plurality of different predetermined thresholds, (ii) calculate the objective function based on the calculated first and second index values, and (iii) update the learning model by using the calculated objective function.
